(19) United States
(12) Patent Application Publication
(10) Pub. No.: US 2026/0287143 A1
(43) Pub. Date: Sep. 24, 2026

(54) MODULAR STACKABLE LIGHT DIFFUSERS

(71) Applicant: 3form, LLC, Salt Lake City, UT (US)

(72) Inventors: Dax K. Pettibone, American Fork, UT (US); Ryan G. Smith, Seattle, WA (US); Guillaume Martin, Rochetoirin (FR); Justin-Elliot E. Vanier, West Valley City, UT (US); Bryce C. Anderson, Renton, WA (US)

(21) Appl. No.: 19/571,327

(22) Filed: Mar. 18, 2026

Related U.S. Application Data
(60) Provisional application No. 18/445,686, filed on Mar. 18, 2025.
(60) Provisional application No. 18/445,685, filed on Mar. 18, 2025.

(51) Int. Cl. F21V 3/02

(52) U.S. Cl. CPC F21V 3/02

(57) ABSTRACT

A modular light fixture includes collars, shades, and diffusers that are selectively combinable to form configurable lighting assemblies. A plurality of diffusers is configured to couple end-to-end to form a diffuser bar extending along a longitudinal axis. Each diffuser may include one or more connectors and one or more external fins. The fins are configured to engage corresponding slots defined by neck portions of adjacent shades to inhibit relative rotational movement between the shades when assembled. A collar may include one or more indexes configured to engage a shade to secure the collar relative to the shade, while a connector of a diffuser engages a connection element of the collar in a manner that resists axial separation and permits relative rotation. The modular configuration allows stacked shade arrangements, controlled rotational locking, and adjustable diffuser bar lengths.

### CROSS-REFERENCE TO RELATED APPLICATIONS

This application claims the benefit of and priority to U.S. Provisional Application No. 63/773,635 (Workman Nydegger Docket No. 15999.717), entitled MODULAR STACKABLE LIGHT DIFFUSERS, filed on Mar. 18, 2025, and U.S. Provisional Application No. 63/773,627 (Workman Nydegger Docket No. 15999.716), entitled MODULAR STACKABLE LIGHT FIXTURE, filed on Mar. 18, 2025. This application also incorporates the entirety of U.S. patent application Ser. No. ______ [Workman Nydegger Docket Number: 15999.716.1] for which the law firm of Workman Nydegger is authorized to update with the filing receipt of the same upon receipt), entitled “MODULAR STACKABLE LIGHT FIXTURE”, filed on Mar. 18, 2026, the entire content of which is incorporated by reference herein. [U.S. PROVISIONAL APPLICATION NO. 63/773,635 (****ATTORNEY DOCKET 15999.717*****) AND 63/773,627 (****ATTORNEY DOCKET NUMBER 15999.716******) ARE THE SUBJECT OF CORRESPONDING PETITIONS TO CONVERT FROM PROVISIONAL TO UTILITY, NAMELY IN BOTH OF THE ABOVE PROVISIONAL APPLICATIONS ON MAR. 9, 2025. APPLICANTS AUTHORIZE THE LAW FIRM OF WORKMAN NYDEGGER TO UPDATE THE ABOVE TEXT TO REFLECT THE NON-PROVISIONAL APPLICATION NUMBERS WHEN KNOWN).

### BACKGROUND OF THE INVENTION

### 1. Technical Field

The present invention pertains to modular stackable lighting systems and locking diffusers.

### 2. Background and Relevant Art

Conventional lighting systems often feature static designs that limit customization and adaptability. These systems may include fixed components that do not allow for easy replacement or modification, which can be problematic for users seeking to update their decor or repair damaged parts. Additionally, traditional lighting systems may rely on mechanical fasteners or adhesives that can be cumbersome to assemble and disassemble, potentially leading to wear and tear over time.

Furthermore, conventional lighting systems typically lack modularity or expandability, meaning users cannot easily change the appearance or functionality of their fixtures. This rigidity can be a significant drawback for those who desire a more dynamic, personalized lighting solution. The materials used in traditional lighting systems may also be limited in variety, restricting the range of aesthetic and functional effects that can be achieved.

Accordingly, there are a number of disadvantages in the art that can be addressed.

### BRIEF SUMMARY OF THE INVENTION

Implementations of the present invention comprise systems, methods, and apparatus related to modular lighting fixtures. In particular, implementations of the present invention can comprise collars, shades, and diffusers that enable a user or assembler to construct or reconfigure cost-effective modular light fixtures and diffuser bars that align with aesthetic and functional design goals.

For example, in an implementation, a modular light fixture may include a plurality of diffusers that can be configured to couple end-to-end to form a diffuser bar having a first terminal end and a second terminal end. Each of the diffusers can include an outer shell extending along a longitudinal axis and an internal bore extending along substantially a length of the outer shell. Each diffuser may also include a first connector at a first end and a second connector at a second end, the second connector having a threaded portion. Each diffuser may also include one or more fins extending radially from the outer surface of the outer shell, which are selectively engageable with the modular light fixture.

In another implementation, a locking diffuser for use in a modular light fixture may include an outer shell having a length and an internal bore extending through the outer shell and defining an opening at a first end and a second end of the outer shell. The locking diffuser may include a first connector disposed at the first end, and a second connector disposed at the second end. The second connector can include an internal threaded portion that extends along at least a quarter of the length of the outer shell. The locking diffuser may also include one or more fins extending radially from an outer surface of the outer shell. The one or more fins may selectively engage notches within the modular light fixture.

In yet another implementation, a collar and diffuser assembly for use in modular light fixtures may include a collar. The collar may include a body having an upper surface and a lower surface, one or more walls extending from the lower surface of the body, one or more apertures extending through the body, and a connection element. The collar and diffuser assembly may also include a diffuser. The diffuser may include an outer shell extending along a longitudinal axis, and a connector configured to engage the connection element of the collar. The connection element of the collar can engage the connector of the diffuser and resist axial separation while allowing for rotational movement of the diffuser relative to the collar.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a cross-sectional view of a modular light fixture of the present disclosure;

FIG. 2A illustrates a perspective view of a diffuser of the present disclosure;

FIG. 2B illustrates a perspective view of another embodiment of a diffuser of the present disclosure;

FIG. 2C illustrates a perspective view of a locking diffuser of the present disclosure;

FIG. 2D-1 illustrates a perspective view of another implementation of a locking diffuser of the present disclosure;

FIG. 2D-2 illustrates a cross-sectional view of the locking diffuser of FIG. 2D-1;

FIG. 2E-1 illustrates a perspective view of another implementation of a locking diffuser of the present disclosure;

FIG. 2E-2 illustrates a cross-sectional view of the locking diffuser of FIG. 2E-1;

FIG. 3A illustrates a cap of the present disclosure;

FIG. 3B illustrates another implementation of a cap of the present disclosure;

FIG. 3C illustrates yet another implementation of a cap of the present disclosure;

FIG. 4A illustrates a cross-sectional view of a modular light fixture including locking diffusers of the present disclosure;

FIG. 4B illustrates another cross-sectional view of a modular light fixture including locking diffusers of the present disclosure;

FIG. 5 illustrates side perspective views of two shades of the present disclosure;

FIG. 6A illustrates a top perspective view of a collar of the present disclosure;

FIG. 6B illustrates a bottom perspective view of a collar of the present disclosure;

FIG. 6C illustrates a side cross-sectional view of a collar of the present disclosure;

FIG. 7A illustrates another top perspective view of a collar of the present disclosure;

FIG. 7B illustrates another bottom perspective view of a collar of the present disclosure;

FIG. 7C illustrates another side cross-sectional view of a collar of the present disclosure;

FIG. 8 illustrates a method of assembling a modular light fixture;

FIG. 9 illustrates a sequence of inserting a film of the present disclosure;

and

FIG. 10 illustrates various length diffusers of the present disclosure.

### DETAILED DESCRIPTION OF THE PREFERRED EMBODIMENTS

The present invention extends to systems, methods, and apparatus related to modular lighting fixtures. In particular, implementations of the present invention can comprise collars, shades, and diffusers that enable a user or assembler to construct or reconfigure cost-effective modular light fixtures that align with aesthetic and functional design goals.

Accordingly, the present disclosure relates to modular light fixtures and diffuser bars for use in public and private spaces. Specifically, the present disclosure provides modular light fixtures with removable shades and collars configured for tool-less locking and assembly. The shades can couple together to provide long totem or stacked light fixtures that can be hung from a ceiling or elevated position or mounted to a floor or wall surface. Users of modular light fixtures of the present disclosure will appreciate their configurability and customizability, as they allow a user or assembler to assemble or reconfigure them in a cost-effective and modular manner, as components and features can be shared between suspended/hanging fixtures, standing fixtures, mounted fixtures, etc. For example, the modularity of the diffusers of the present disclosure allows continuous light emission throughout the length of the stacked lighting fixtures described herein via end-to-end coupling into continuous diffuser bars.

As used herein, the term “end-to-end” refers broadly to an arrangement in which a first component is positioned adjacent to and coupled with a second component along corresponding terminal portions of each component. The coupling may occur through direct contact, partial overlap, interfacing coupling elements, or intermediary structures, and need not require flush abutment of terminal edges. The term encompasses axial alignment, substantially axial alignment, and configurations in which the components are aligned along a common longitudinal axis or a generally continuous path.

These diffuser bars also allow the shades that make up the stacked lighting fixtures to be secured together. In particular, the end-to-end coupling of adjacent diffusers forms a mechanically continuous structure that resists rotational loosening and axial separation of shades, thereby preventing inadvertent decoupling of the diffusers during assembly, handling, or operation of the lighting fixture.

Users can assemble or reconfigure modular light fixtures of the present disclosure through the decoupling/recoupling of a collar from the shades. For example, a user can insert a collar into the neck of a shade and twist it relative to the shade to cause a frictional fit between engagement elements of the collar and elements within the neck of a shade. The user can also couple a diffuser bar with the collar, such that the diffuser bar is securely held within the length of the modular light fixture and acts to resist the decoupling of one or more shades.

Manufacturers of modular light fixtures of the present disclosure can construct shades, collars, and diffusers from Polylactic Acid (PLA), Polyethylene Terephthalate Glycol (PETG), Acrylonitrile Butadiene Styrene (ABS), Polycarbonate (PC), Thermoplastic Polyurethane (TPU), Polyvinyl Alcohol (PVA), Polyethylene (PE), or a similar material. Manufacturers may also construct shades, collars, and diffusers from metals, alloys, wood, composites, and rubbers, among other materials. A manufacturer can choose the material based on the specific aesthetic or functional design goal for the modular lighting fixture. For example, PLA can be used in a 3D printer to produce components with a smooth finish that provide a sleek, clean aesthetic. Alternatively, PETG can be selected for its durability and flexibility characteristics.

The manufacturer can choose a colored/pigmented material or utilize colored/pigmented inserts (film) within the diffuser to change the perceived color of the light output by the modular light fixtures. The colored inserts may be transparent or semi-transparent films that can be rolled up to fit inside the diffusers. In the case of a diffuser bar, an assembler can install a single long film within all the diffusers that make up the diffuser bar rather than an individual film for each diffuser. By rolling the film up first, an assembler can allow the film to unfurl inside the diffusers, causing the film to be frictionally retained within the diffusers. Furthermore, a manufacturer can selectively texture the surfaces of the shades and diffusers. For example, a manufacturer may apply a rough texture to a diffuser of the present disclosure to alter the light-diffusion effects of the diffuser. In another embodiment, however, a manufacturer may apply a smooth texture or a patterned texture to the diffuser. The choice of texture can be driven by aesthetic or functional considerations.

While the present disclosure teaches hanging light fixtures (horizontal and vertical), modular light fixtures can be configured to reside on tables, floors, and walls. Additionally, the modularity of the modular light fixtures allows a user to easily disassemble and reassemble them for regular cleanings without having to undergo a complex disassembly process.

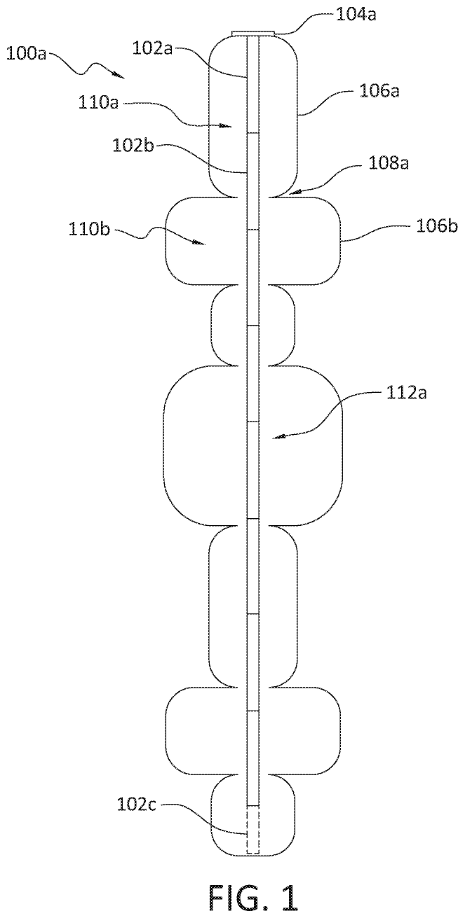

Turning now to the Figures, FIG. 1 illustrates modular light fixture 100a. Light fixture 100a can include shade 106a and 106b (and various other shades), diffuser 102a and 102b (and various other diffusers), and collar 104a. As illustrated, light fixture 100a has seven total shades of the present disclosure. Users can selectively set the overall length of their light fixtures by choosing how many shades to include and the dimensions of each shade. As shown, all shades in the light fixture 100a are substantially cylindrical. Manufacturers can construct the shades of the present disclosure into any geometric shape, such as squares, triangles, rectangles, cones, cylinders, or spheres. A manufacturer may also construct the shade in non-geometric shapes. Although illustrated in a vertical configuration, light fixture 100a may be oriented vertically, horizontally, or at an angled orientation during use.

Shade 106a can couple end-to-end with shade 106b via joint 108a. Joint 108a can denote a place where a coupling element disposed on either shade 106a or 106b may selectively engage with a corresponding element disposed on the other shade. For example, a twist-lock mechanism and/or a retention mechanism (e.g., a set screw, magnet, etc.) can secure shades 106a and 106b together at joint 108a. Joint 108a also joins the internal space 110a (defined by shade 106a) with internal space 110b (defined by shade 106b). In some embodiments, the coupling element at joint 108a is configured to resist both axial separation and relative rotational motion between shades 106a and 106b once engaged.

In certain implementations, adjacent diffusers 102a and 102b are secured by threaded engagement, friction fit, set screws, or combinations thereof. Such engagement mechanisms can prevent relative rotation between adjacent diffusers and can further prevent axial disengagement once assembled. As a result, diffuser bar 112a functions as a structural spine extending through the stacked configuration of shades. In some embodiments, diffuser bar 112a is maintained in substantially concentric alignment within internal spaces 110a and 110b by engagement with one or more internal surfaces of the shades, joints, or collar 104a. Such alignment can reduce the lateral movement of the diffuser bar relative to the shades.

FIG. 1 shows that at least a portion of the diffuser bar 112a can be received within the internal spaces 110a and 110b, which are defined by the shades. Diffuser bar 112a can be centrally secured within internal spaces 110a and 110b and continue through internal spaces defined by additional shades. Diffuser bar 112a can include diffusers 102a and 102b, as well as any number of additional diffusers. An assembler can selectively secure the diffusers 102a and 102b together through various coupling or fastening means. An outer surface of diffuser 102b may abut an internal surface of joint 108a. Diffuser 102a and 102b may have uniform dimensions, such as overall length.

Diffuser bar 112a can promote substantially uniform light emission along its length. By distributing light received from one or more light sources throughout the internal bore and across the material of the diffusers, the diffuser bar can reduce visible hotspots and minimize abrupt changes in brightness between adjacent shades. As a result, light fixture 100a can emit a substantially constant illumination along its stacked length, providing a consistent warmth and glow across the assembled shades.

FIG. 1 shows that diffuser bar 112a may have an overall length similar to the combined length of the shades. As illustrated, diffuser 102c represents a diffuser of similar dimensions to diffusers 102a and 102b prior to trimming. In some embodiments, diffusers of the present disclosure are manufactured with a uniform overall length to promote modularity and interchangeability. For example, an assembler could have included a full-sized final diffuser rather than a cut-down diffuser (102c) (shown in dashed lines); however, it would likely have extended out from within the final shade. In embodiments in which the internal bore includes threading that extends substantially continuously along its length, a diffuser may be cut or shortened to a desired dimension without eliminating its ability to couple to an adjacent diffuser, as usable threading remains along the remaining portion after trimming. This allows an assembler to tailor the overall length of diffuser bar 112a so that it does not extend past the end of the final shade while maintaining secure threaded engagement between adjacent diffusers.

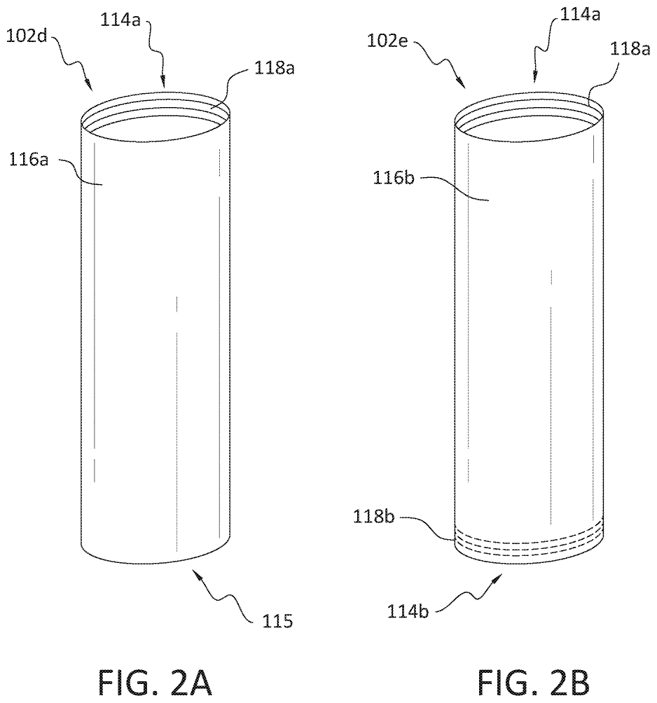

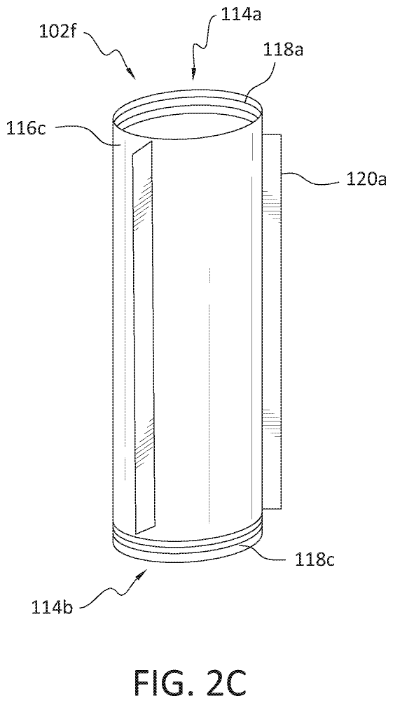

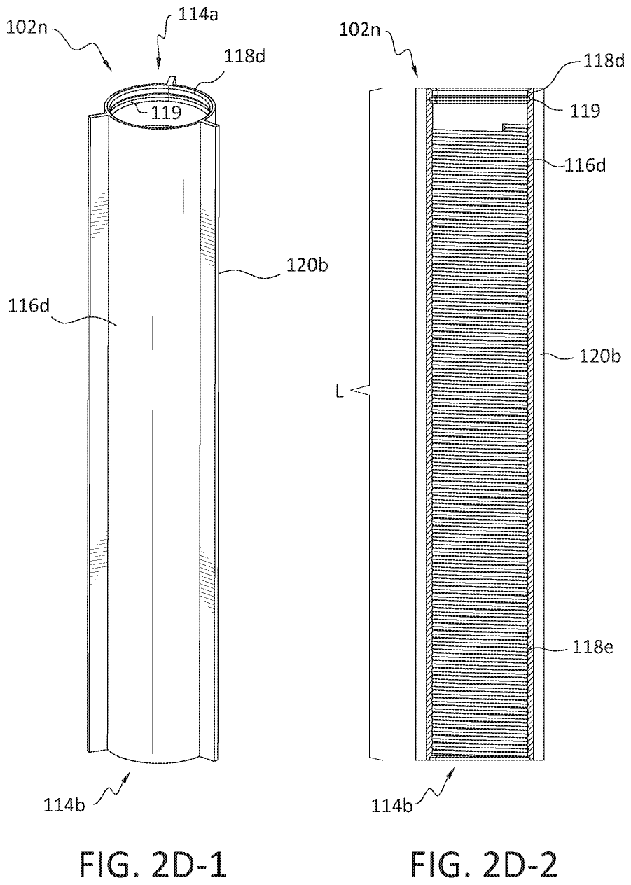

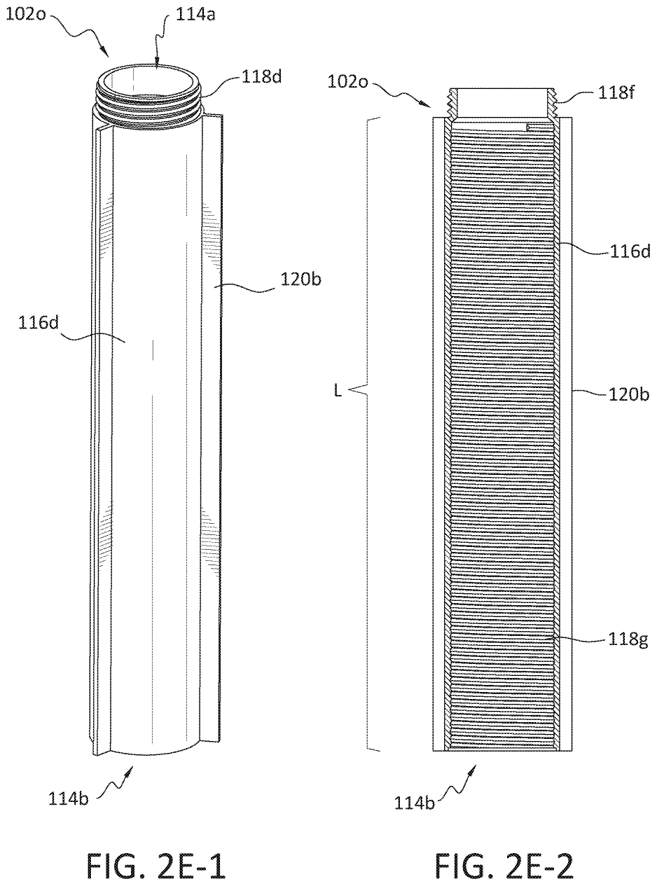

Diffuser bar 112a may include only a single diffuser, only two diffusers, only three diffusers, or any plurality of diffusers coupled end-to-end. In certain configurations, diffuser bar 112a may include a single diffuser of a first type, such as the configuration illustrated in FIG. 2D-1. In other configurations, diffuser bar 112a may include a plurality of diffusers of the same type, such as illustrated in FIG. 2E-1, or a combination of different diffuser types having differing coupling layouts or mechanisms. Accordingly, the modular diffuser architecture permits variation in both overall length and coupling configuration while maintaining structural and functional continuity.

FIG. 2A through FIG. 2E-2 illustrate various embodiments of diffusers and locking diffusers of the present disclosure. Specifically, FIG. 2A shows diffuser 102d. Diffuser 102d can have an opening 114a (e.g., an internal bore), defined by the outer shell 116a. Diffuser 102d may be formed by extrusion, molding, machining, additive manufacturing, or combinations thereof. Opening 114a can be a through-hole or bore that extends through the entirety or at least a portion of the outer shell. In some embodiments, opening 114a is substantially coaxial with a longitudinal axis of diffuser 102d and is dimensioned to receive a light source, wiring, a support rod, or a portion of an adjacent diffuser. When coupled end-to-end with another diffuser, opening 114a can align with a corresponding opening of the adjacent diffuser to form a substantially continuous internal passage.

Outer shell 116a can also have a thickness. A manufacturer can configure the thickness and other characteristics of the outer shell 116a to allow varying amounts of light to transmit through the outer shell 116a. For example, material type, thickness, and texture may be varied independently or together to cause the light emitted from a light element within outer shell 116a to be diffused to accomplish a specific aesthetic or functional goal. In one embodiment, outer shell 116a is thick and does not allow light to pass through, while bottom surface 115 is transparent, allowing directional light to pass downwards. In some embodiments, bottom surface 115 defines a closed terminal end of diffuser 102d. In other embodiments, diffuser 102d may be open at both terminal ends such that opening 114a extends completely through diffuser 102d. In another embodiment, a manufacturer constructs the outer shell 116a with a patterned, variable thickness, allowing the diffuser 102d to cast shadows along with the light.

Diffuser 102d can also comprise connector 118a. Connector 118a is illustrated as a threaded portion that can couple to corresponding threaded elements of other diffusers or collars of the modular lighting fixtures of the present disclosure. In another embodiment, connector 118a may be clips, snaps, indexing grooves, hook-and-loop, magnets, or other suitable coupling features. In certain embodiments, connector 118a includes internal threading, external threading, or a combination thereof. The threading may extend along substantially the entire axial length of diffuser 102d, thereby permitting coupling engagement at multiple axial positions and allowing diffuser 102d to be trimmed while retaining functional threading. In some embodiments, threading may be disposed only along one or more portions of diffuser 102d.

FIG. 2B illustrates a perspective view of diffuser 102e. Diffuser 102e can have many of the features and characteristics of diffuser 102d. For example, diffuser 102e can have connector 118a and opening 114a. Diffuser 102e may also have opening 114b and connector 118b, which are both disposed on an opposing end of diffuser 102e relative to connector 118a and opening 114a. Thus, diffuser 102e can be a substantially hollow tube structure. In certain embodiments, connector 118a and connector 118b are complementary coupling features. For example, connector 118a may comprise external threading while connector 118b comprises internal threading, thereby allowing diffuser 102e to directly threadably engage an adjacent diffuser without an intermediary component. Accordingly, when diffuser 102e is coupled to an adjacent diffuser, opening 114a and opening 114b may align with corresponding openings to form a substantially continuous internal cavity extending through multiple diffusers.

FIG. 2B shows that connector 118b is internally disposed on an inner surface of outer shell 116b. In another embodiment, an assembler can dispose connector 118b (or 118a) on the inner or outer surface of outer shell 116b. In some embodiments, threading associated with connector 118a and/or connector 118b extends along substantially the entire axial length of diffuser 102e. In other embodiments, threading may be disposed only near one or both terminal ends. A manufacturer can construct a diffuser 102e with connectors on the inside or outside to allow for diffusers to couple to one another to form a diffuser bar with or without the need of additional coupling rings or elements.

FIG. 2C illustrates a perspective view of locking diffuser 102f. Locking diffuser 102f can have any of the characteristics or features of any other diffuser of the present disclosure. For example, locking diffuser 102f can have connector 118a and openings 114a and 114b. Locking diffuser 102f can also comprise connector 118c and fins 120a. As previously mentioned, connector 118c can reside on the outer surface of outer shell 116c. In certain embodiments, connector 118a and connector 118c are complementary coupling features disposed at opposing terminal ends of locking diffuser 102f. For example, connector 118a may comprise internal threading while connector 118c comprises external threading. This configuration advantageously allows a plurality of locking diffusers to couple together to form a diffuser bar.

Fins 120a can be disposed about the circumferential perimeter of outer shell 116c. As illustrated, three fins are equally spaced around the outer shell 116c. In another embodiment, a manufacturer can include any number of fins (for example, 1, 2, 3, 4, 5, 6, 7, 8, or more than 8). Fins 120a protrude from and extend away from the outer surface of the outer shell 116c. During the additive construction of diffuser 102f, the manufacturer can ensure that fins 120a are formed during the same process. Accordingly, fins 120a may extend longitudinally along at least a portion (for example, for the length of the diffuser, minus the length of one or more connectors) of locking diffuser 102f and may be configured to engage corresponding recesses, slots, or indexing features of adjacent shades or coupling elements. In at least one embodiment, fins 120a extend for the entire length of a diffuser.

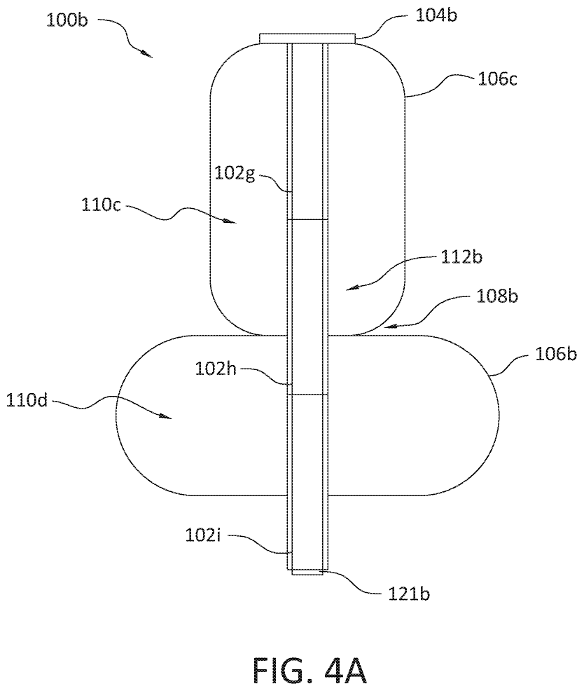

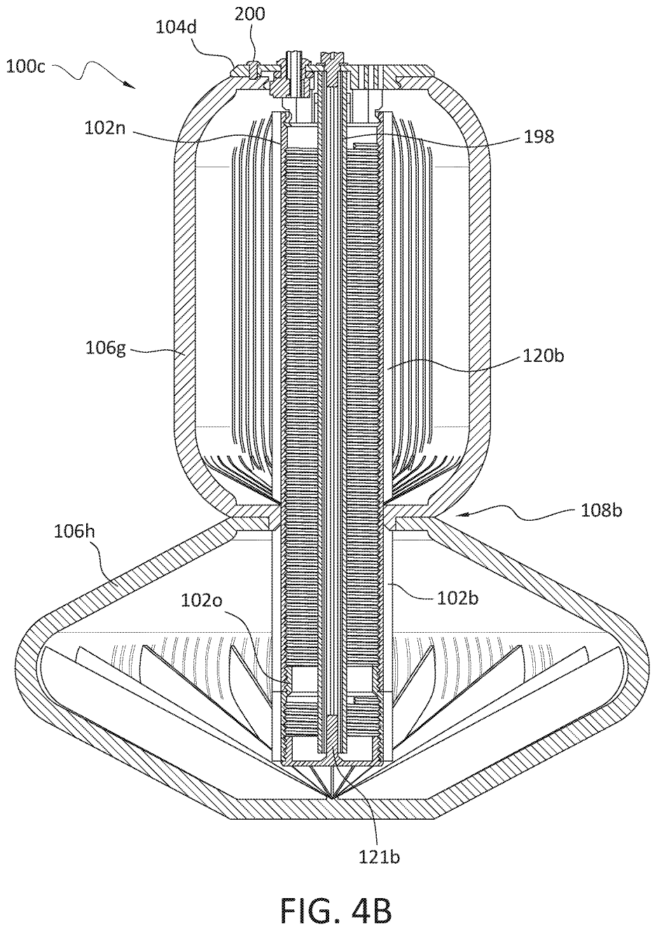

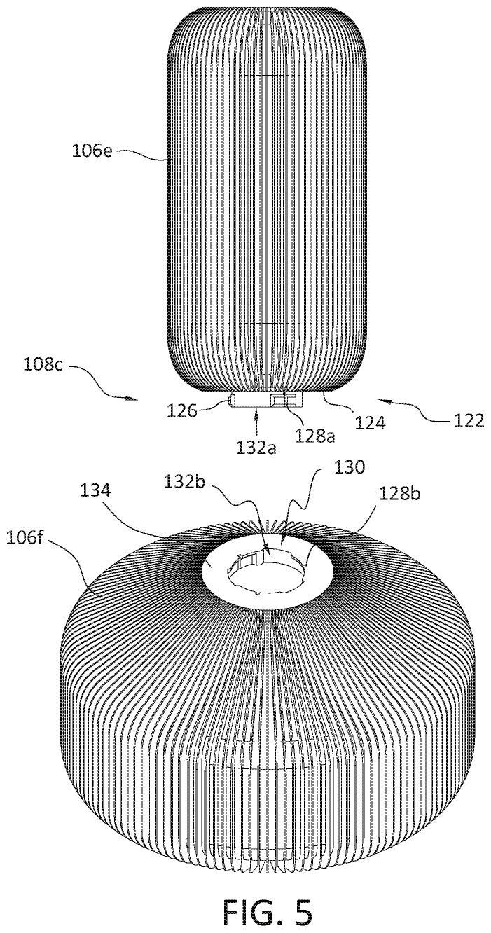

FIG. 2C shows fin 120a, which allows locking diffuser 102f to lock a modular light fixture of the present disclosure, such that the shades do not de-couple without removing the diffuser bar. Fins 120a are configured to interface with slots defined by the neck or coupling elements of shades of the present disclosure to inhibit their rotation relative to one another. (See FIGS. 4A, 4B, and 5).

FIGS. 2D-1 and 2D-2 illustrate locking diffuser 102n. Locking diffuser 102n may include opening 114a and opening 114b defining an internal bore extending along a longitudinal length L of outer shell 116d. As shown in FIG. 2D-2, the internal bore may extend substantially continuously between opposing terminal ends of locking diffuser 102n.

Locking diffuser 102n may further include one or more external fins 120b disposed about the circumferential perimeter of outer shell 116d. In the illustrated embodiment, three fins 120b are shown, although any suitable number of fins may be included. Fins 120b may extend longitudinally along at least a portion of length L. Each fin 120b may have a thickness providing structural rigidity to locking diffuser 102n. The thickness of fins 120b may be greater than, less than, or substantially equal to the thickness of outer shell 116d. In certain embodiments, fins 120b may be relatively thin so as to reduce shadow casting or visual artifacts when light is emitted through adjacent shades, while in other embodiments fins 120b may be thicker to provide enhanced reinforcement or anti-rotation engagement with corresponding shade features.

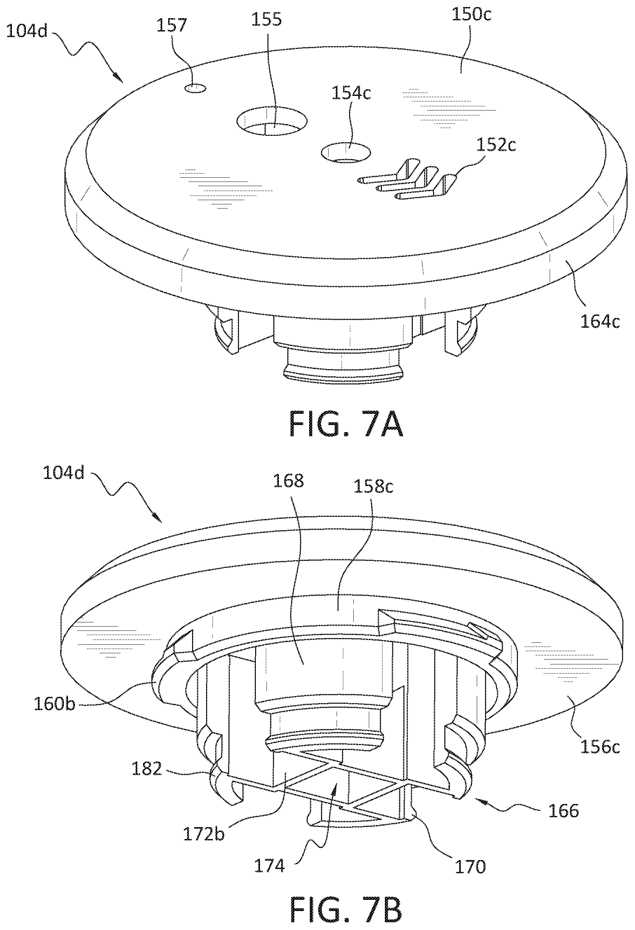

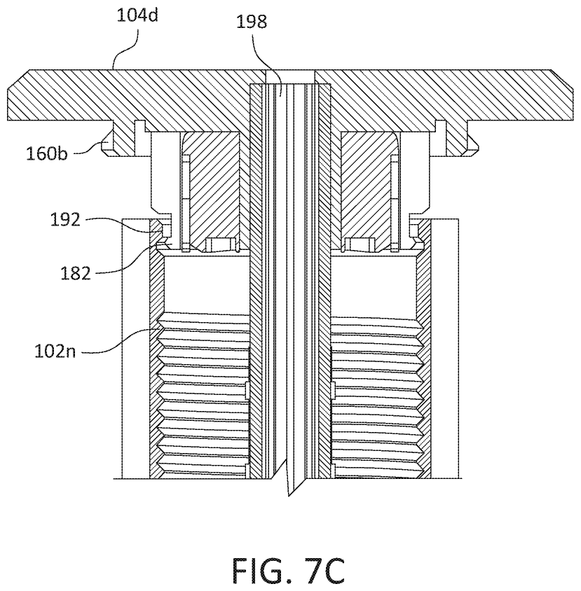

As shown in FIGS. 2D-1 and 2D-2, locking diffuser 102n may include connector 118d disposed near a terminal end. Connector 118d may take the form of a circumferential lip formed by a recess 119 defined in the inner surface of the outer shell 116d. Accordingly, in at least one embodiment, the connection within a collar and diffuser assembly (i.e., between the collar and diffuser) does not include a thread, such as a spiral or screw-style threading. Recess 119 may create an annular shoulder or projection that is configured to engage a correspondingly sized and shaped lip or recess of another component, such as a collar (see, e.g., FIG. 7A). Engagement between a lip (connector 118d) and a corresponding lip of a collar may axially retain locking diffuser 102n while permitting or restricting rotational movement, depending on the configuration.

FIG. 2D-2 further illustrates internal threading (connector 118e) disposed along an inner surface of outer shell 116d. In certain embodiments, connector 118e extends substantially along the entire length L of locking diffuser 102n. For example, connector 118e can extend for a quarter, half, or three-quarters of the length L. Because connector 118e is available along a portion or the entire length L, locking diffuser 102n may be cut or shortened at various axial positions while retaining usable threading for engagement with another diffuser, such as diffuser 1020 illustrated in FIG. 2E-1. As a result, bespoke diffuser lengths need not be manufactured separately, as on-site trimming or adjustment can readily be performed while preserving coupling functionality.

FIGS. 2E-1 and 2E-2 illustrate diffuser 1020, which may be configured as a repeatable diffuser element. Diffuser 1020 may include opening 114a and opening 114b, which define an entrance to an internal bore extending along length L of outer shell 116d. Diffuser 1020 may further include one or more external fins 120b extending longitudinally along at least a portion of outer shell 116d. As shown in FIG. 2E-1, diffuser 1020 includes connector 118f disposed at a first terminal end. Connector 118f may take the form of external threading formed on an outer surface of outer shell 116d. In certain embodiments, connector 118f is complementary to an internally threaded connector of another diffuser.

FIG. 2E-2 illustrates a cross-sectional view of diffuser 1020, showing internal threading (connector 118g) disposed along an inner surface of outer shell 116d. Internal threading of the connector 118g may be similar to internal threading of the connector 118e described above with respect to locking diffuser 102n. In certain embodiments, internal threading (connector 118g) extends substantially along the entire length L of diffuser 1020. Since diffuser 1020 includes complementary coupling features, such as external threading (connector 118f) at one terminal end and internal threading (connector 118g) along its internal bore, multiple diffusers 1020 may be directly coupled end-to-end in a repeatable manner. This configuration allows diffuser 1020 to function as a modular, stackable element capable of forming diffuser bars of variable and potentially indefinite length. In embodiments in which internal threading (connector 118g) extends substantially along length L, diffuser 1020 may be cut or shortened at various axial positions while retaining usable threading for engagement with another diffuser. Accordingly, standardized diffuser units may be manufactured and later modified on-site to accommodate specific installation requirements without requiring bespoke manufacturing.

In certain configurations, a diffuser bar may begin with a diffuser 102n positioned at or near a collar to permit controlled rotational engagement via connector 118d, while one or more repeatable diffusers 1020 are coupled thereafter to extend the overall length of the diffuser bar. By using a diffuser 102n with a connector 118d (e.g., a lip), unlike a threaded configuration in which rotation causes axial separation, the lip allows rotation about the axis while resisting axial separation. Because the connectors of diffusers 102n and 1020 are complementary and alignable, any combination and ordering of diffusers 102n and 1020 may be employed to achieve a desired structural and functional configuration.

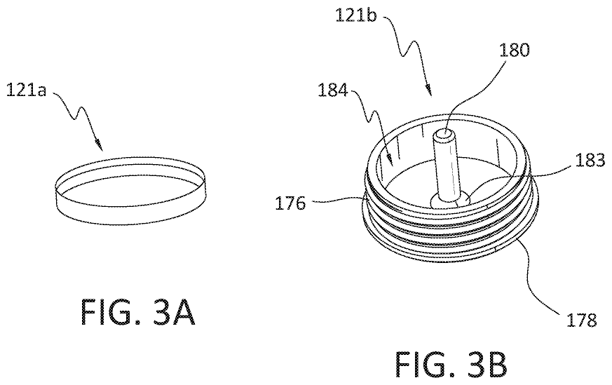

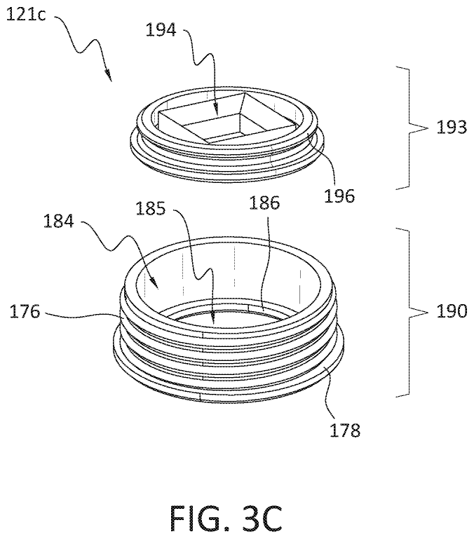

FIG. 3A illustrates cap 121a. A manufacturer can configure cap 121a to couple to a terminal end of any diffuser of the present disclosure to define a closed end. In certain embodiments, cap 121a is configured to threadingly engage a diffuser via internal or external threading. For example, cap 121a may include internal threads configured to engage external threads of a diffuser, or external threads configured to engage internal threads of a diffuser. In other embodiments, cap 121a may couple via friction fit, snap engagement, or other suitable coupling mechanisms.

Cap 121a may prevent light from exiting the terminal end of the diffuser and may redirect or focus emitted light in a selected direction, such as downward along a longitudinal axis of the diffuser bar. In certain embodiments, cap 121a is substantially opaque to block light transmission, while in other embodiments, cap 121a may be translucent or transparent. In some embodiments, cap 121a has a thickness substantially similar to the thickness of the outer shell of the diffuser to which it is attached. Maintaining a similar thickness may promote consistent diffusion characteristics and reduce visible discontinuities in light emission at the interface between the diffuser and cap 121a.

FIG. 3B illustrates cap 121b. Cap 121b may include threaded walls 176 extending from base 178. Threaded walls 176 may define, at least in part, an internal space 184. In certain embodiments, threaded walls 176 include internal threading configured to engage corresponding external threading of a diffuser. In other embodiments, threaded walls 176 may include a lip, snap feature, friction interface, or other connector type configured to couple cap 121b to a diffuser of the present disclosure.

Extending from base 178 and at least partially within space 184 is pin 180. Pin 180 may be configured to engage a lighting support structure, such as a rod, conduit, or internal structural member extending through a diffuser bar. In certain configurations, pin 180 provides a centering function by engaging the lighting support structure at a location spaced from a collar of the modular lighting fixture. Thus, pin 180 may provide a second point of contact, in addition to the collar, thereby providing axial alignment and reducing lateral movement of the diffuser bar relative to the lighting support structure.

In some embodiments, pin 180 includes a tapered portion 183. Tapered portion 183 may have a diameter greater than the remaining portion of pin 180 such that, once inserted into an aperture of the lighting support structure, tapered portion 183 engages an inner surface of the aperture. This engagement may help retain pin 180 within the aperture and further reduce relative movement between cap 121b and the lighting support structure.

FIG. 3C illustrates cap 121c, which may include a first portion 190 and a second portion 193. First portion 190 may include threaded walls 176 and base 178. Threaded walls 176 may be configured to threadingly engage a diffuser of the present disclosure. Base 178 may define one or more apertures 185 such that space 184 forms a through-cavity extending through first portion 190. In certain embodiments, the first portion 190 further includes a circumferential lip 186 or similar connector disposed within space 184.

The second portion 193 may be configured to couple to the first portion 190 (such as within the space 184). As illustrated, the second portion 193 may include a circumferential lip 196 configured to engage the circumferential lip 186 of the first portion 190. Because lips 186 and 196 are circumferential, second portion 193 may remain axially retained relative to first portion 190 while permitting rotational movement between the two portions. The second portion 193 may further define aperture 194 shaped to receive a lighting support structure, such as a rod, conduit, or structural member extending through a diffuser bar. Engagement between aperture 194 and the lighting support structure may provide a second point of contact in addition to a collar of the modular lighting fixture, thereby retaining the lighting support structure in a centered position.

In operation, the first portion 190 may be secured to a diffuser, while the second portion 193 engages the lighting support structure. Because the second portion 193 is rotatable relative to the first portion 190, the lighting support structure and collar may rotate together without requiring rotation of the diffuser bar. This configuration allows the lighting support structure and collar to rotate relative to the diffuser bar while remaining mechanically coupled, thereby reducing torsional stress on the diffuser assembly and facilitating installation or adjustment.

FIG. 4A illustrates a cross-sectional view of modular light fixture 100b, including locking diffusers 102g, 102h, and 102i (which together form a diffuser bar), which are coupled to collar 104b. Locking diffusers 102g, 102h, and 102i can selectively couple to one another via connectors (not shown; see FIG. 2C, 2D-1, 2E-1). An assembler can ensure that when threaded together, the fins of each locking diffuser are aligned to form contiguous fins along the entire length of the diffuser bar 112b. An assembler will appreciate that this orientation can facilitate the easy insertion or removal of diffuser bar 112b from internal spaces 110c and 110d. As previously discussed, the diffuser bar 112b fins can interface with slots within the shades and are positioned near or at the joint 108b. FIG. 5 illustrates these slots in further detail. This interfacing arrangement may prevent shade 106c from twisting relative to shade 106d, meaning shade 106c and 106d may be inseparable until diffuser bar 112b is removed from the modular light fixture 100b. Users of the modular light fixture 100b will appreciate that this prevents accidental separation when they hang their modular light fixture 100b.

In addition to inhibiting rotation, the engagement between diffuser bar 112b and joint 108b may provide lateral stabilization of the diffuser bar within internal spaces 110c and 110d, thereby reducing vibration and maintaining alignment of the light source relative to the shades.

FIG. 4B illustrates a cross-sectional view of modular light fixture 100c. Light fixture 100c includes shades 106g and 106h coupled end-to-end at joint 108b. In certain embodiments, joint 108b may include a twist-lock engagement mechanism configured to secure shade 106g to shade 106h. Collar 104d may be coupled to shade 106g using one or more indexing features and retained in position by retention mechanism 200, such as a set screw. Collar 104d may further engage locking diffuser 102n through a lip-to-lip connector arrangement. In this configuration, a circumferential lip of collar 104d engages a corresponding circumferential lip of locking diffuser 102n. This engagement may resist axial separation between collar 104d and locking diffuser 102n while permitting relative rotational movement therebetween.

Locking diffuser 102n is shown extending through the internal space of shade 106g, through joint 108b, and into the internal space of shade 106h. A second diffuser 1020 may be coupled to the locking diffuser 102n to extend the diffuser bar. In the illustrated embodiment, diffuser 1020 is shortened to accommodate the internal geometry of shade 106h, which does not include an aperture that would allow diffuser 1020 to extend beyond its internal space. Because diffuser 1020 may include continuous internal threading, it may be cut to a desired length while retaining functional engagement with locking diffuser 102n.

FIG. 4B shows that fins 120b of locking diffuser 102n extending longitudinally through the internal spaces of shades 106g and 106h and through joint 108b. Engagement between fins 120b and corresponding slots defined at or near joint 108b inhibits relative rotational movement between shade 106g and shade 106h. Accordingly, while locking diffuser 102n is installed, the shades are restrained from twisting relative to one another. Because the diffuser bar is rotationally restrained relative to the shades, the lip-to-lip engagement between collar 104d and locking diffuser 102n allows collar 104d to rotate relative to the diffuser bar without causing rotation of the diffusers. This configuration permits collar 104d to be rotated into a locked position relative to shade 106g while the diffuser bar remains stationary.

Cap 121b is shown coupled to the lower terminal end of the diffuser bar. A pin of cap 121b is shown extending into lighting support structure 198, which extends between collar 104d and end cap 121b. Engagement of lighting support structure 198 at both collar 104d and end cap 121b provides two spaced points of contact, promoting axial alignment and centering of the diffuser bar. This dual-point support may reduce vibration and maintain alignment of the light source, even when modular light fixture 100c is oriented horizontally rather than vertically.

Lighting support structure 198 may comprise an extruded member, rod, tube, channel, rail, or similar structural element extending along the longitudinal axis of the diffuser bar. In certain embodiments, lighting support structure 198 functions primarily as a mechanical support for one or more light sources. In other embodiments, lighting support structure 198 may itself incorporate or define the light source. For example, lighting support structure 198 may include or support LED strips, LED boards, linear LED modules, fluorescent elements, solid-state lighting arrays, or other suitable illumination devices. Electrical conductors may extend along or within the lighting support structure 198 to supply power to the light source.

FIG. 5 illustrates side perspective views of shades 106e and 106f. FIG. 5 is an exploded view of joint 108c. Shade 106e can comprise connection element 122. Connection element 122 can protrude downward and away from the bottom surface 124 of shade 106e. Connection element 122 can comprise one or more indexes 126 and slots 128a. Indexes 126 protrude perpendicular to bottom surface 124, enabling an assembler to interface connection element 122 with neck 130 of shade 106f. Slot 128a is a cutout or opening defined by connection element 122. The dimensions of slot 128a are determined by the dimensions of the fins that will be used on a locking diffuser to ensure a secure fit with minimal give. Connection element 122 defines the dimensions of opening 132a. Neck 130 may further define one or more slots 128b configured to align with slots 128a when shades 106e and 106f are coupled.

FIG. 5 also illustrates shade 106f. Shade 106f can comprise neck 130, which defines opening 132b. Openings 132a and 132b align and allow the passage of a diffuser bar between the internal spaces defined by shades 106e and 106f. Neck 130 can have an upper surface 134 that abuts the bottom surface 124 when shades 106e and 106f are coupled. Bottom surface 124 and upper surface 134 can have magnets (not shown) embedded inside them, allowing an assembler to secure the two shades together. Neck 130 receives coupling element 122, and index 126 interfaces with neck 130 to frictionally secure the two shades together. In certain embodiments, the engagement between index 126 and neck 130 may also resist axial separation once fully engaged. In other embodiments, mechanical retention features such as detents, friction interfaces, or threaded engagement may be used in place of magnets.

An assembler can insert coupling element 122 into neck 130 and twist shade 106f relative to shade 106e. This twisting can engage index 126 with neck 130 as well as the magnets embedded within the bottom surface 124 with the magnets embedded within the upper surface 134. This twist locking procedure can also align slots 128a and 128b, forming a contiguous slot that can receive the fins of a locking diffuser. When a locking diffuser is inserted, the fins are received within the aligned slots 128a and 128b, thereby inhibiting relative rotational movement between shades 106e and 106f. The size of the innermost circumference of connection element 122 defines the circumference or size of the outer shell of a diffuser.

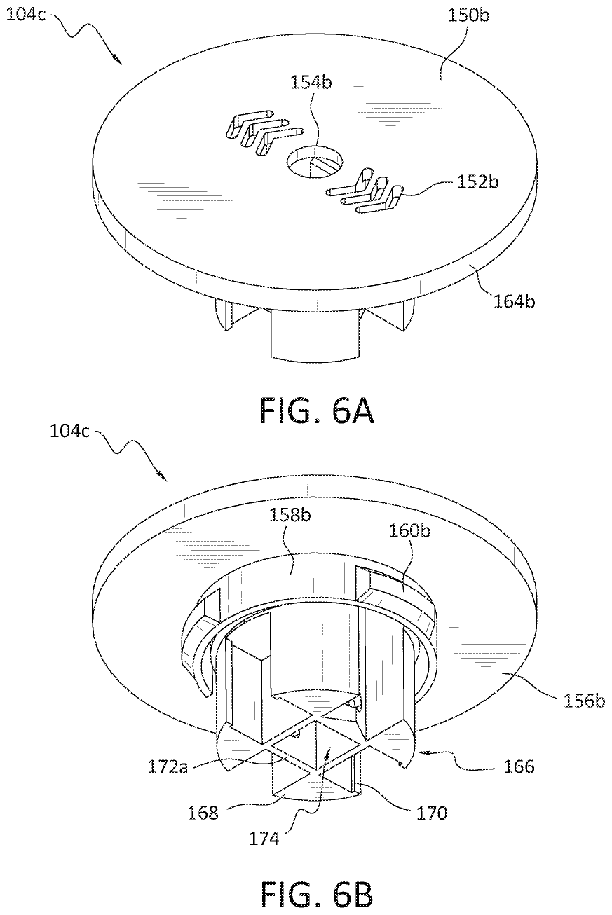

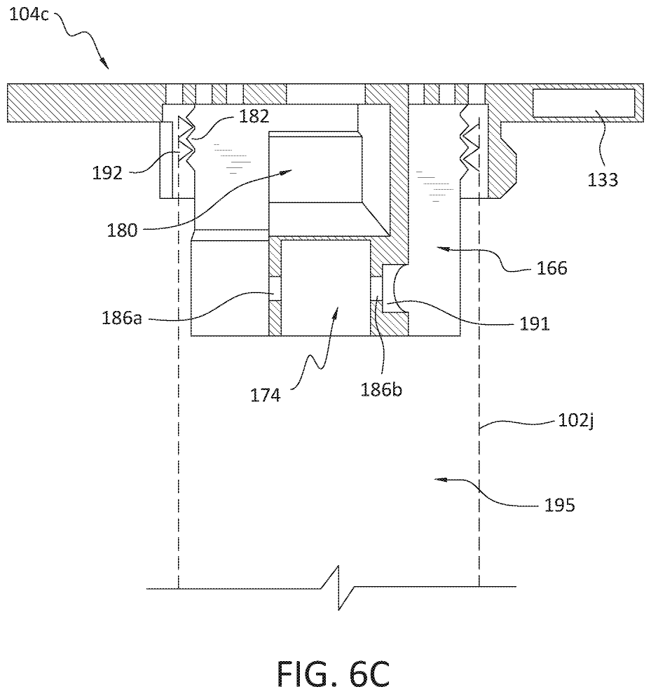

FIG. 6A illustrates a top-perspective view of collar 104c. Collar 104c can include an upper surface 150b, apertures 152b and 154b, and body 164b. Upper surface 150b can be substantially circular. In another embodiment, upper surface 150b can take a different geometric shape, such as a square or triangle. Upper surface 150b can define one or more apertures 152b and 154b. Upper surface 150b may have a thickness selected to provide structural rigidity and to support loads transmitted from suspended shades. In some embodiments, a collar can be enlarged to act as a lamp base or mounting plate. Apertures 152b can allow for the passage of warm air that may build up inside a shade to which collar 104c connects. Aperture 154b can selectively couple to supports, cables, or mounts (not shown) to secure collar 104c to a ceiling, floor, wall, or other support surface. Aperture 154b can also allow for the passage of wires or cables from outside a shade into a shade. Collar 104c can couple with shades of the present disclosure.

In certain embodiments, apertures 152b may also serve as indexing or engagement features for coupling collar 104c to a shade or internal component. In an additional embodiment, an assembly may insert a tool into apertures 152b and 154b to tighten or loosen the collar 104c relative to a shade.

FIG. 6B illustrates a bottom perspective view of collar 104c. Collar 104c can include wall 158b, indexes 160b, and bottom surface 156b. Index 160b may be configured to engage complementary recesses or features of a shade to rotationally position and secure collar 104c relative to the shade. Collar 104c can also include structure 166. Structure 166 may provide internal reinforcement and a mounting interface for a lighting support structure. Structure 166 can comprise one or more corners 168. Each corner 168 can have a ridge 170. Ridge 170 can secure componentry inside collar 104c or act as indexes or slots that interface with componentry. For example, ridge 170 may engage a corresponding recess, groove, or edge of an internal component to prevent rotational or axial displacement.

Componentry can include lighting elements, wiring, fasteners, portions of shade, tinted material layers, etc. Support structure 166 can also include one or more panels 172a. Panel 172a can define a center opening 174. Center opening 174 can have one or more apertures defined by panels 172a configured to receive fasteners. Center opening 174 can receive a lighting support structure or member (e.g., extruded aluminum) that supports a light element positioned within a modular lighting fixture. The member can be secured to support using apertures defined by the support structure 166. (see FIGS. 6C, apertures 186a and 186b).

FIG. 6C illustrates a side cross-sectional view of the collar 104c. Diffuser 102j can have a connector 192 (e.g., a thread) (which is analogous to connectors of the present disclosure) that corresponds to connector 182, which allows an assembler to secure the diffuser 102j to collar 104c. As discussed previously, a portion of the support structure 166 can be received within space 195, which is defined by the internal volume of the diffuser 102j. Compartment 133 is also shown embedded within the upper surface of collar 104c. A plurality of magnets can reside within compartment 133 or similar compartments spaced around collar 104c.

FIG. 6C also shows apertures 186a and 186b aligned, providing a pass-through through center opening 174. An assembler may pass a fastener through apertures 186a and 186b to secure an extrusion or member into center opening 174. This provides a secure anchor point to support a light element of the present disclosure. A light element may be adhered or otherwise secured to the secured extrusion or member. Countersink 191 allows the head of a fastener to sit flush, not protruding into space where additional componentry may be needed.

FIGS. 7A and 7B illustrate collar 104d. FIG. 7A is a top perspective view of collar 104d, and FIG. 7B is a bottom perspective view thereof. Collar 104d may be configured to couple to both a shade and a diffuser within a modular lighting fixture while also supporting a lighting support structure. As shown, collar 104d may include upper surface 150c and body 164c extending downward therefrom. Upper surface 150c may be substantially circular, although other geometric shapes are contemplated. Upper surface 150c may define one or more apertures 152c, 154c, 155, and 157. Apertures 152c may function as ventilation openings to allow heat to escape from within a shade. Aperture 154c may be configured to mount collar 104d to a support structure, such as a cable, rod, ceiling mount, floor mount, or other suspension member. Aperture 155 may allow electrical conductors, wiring, or other electronic components to pass through collar 104d into the interior of a shade. Aperture 157 may be configured to receive a retention mechanism, such as a set screw, that secures collar 104d relative to a shade, diffuser, or lighting support structure. In certain embodiments, upper surface 150c has a thickness selected to provide structural rigidity sufficient to support suspended shades and internal components.

As shown in FIG. 7B, collar 104d may include wall 158c and bottom surface 156c. One or more indexes 160b may extend from wall 158c and may be configured to engage complementary recesses or features of a shade to rotationally position and secure collar 104d relative to the shade. In certain embodiments, indexes 160b include notches or stop surfaces that limit rotational travel and prevent over-rotation during assembly. Such stop features may define predetermined rotational positions of collar 104d relative to the shade.

Collar 104d may also further include a lip structure (connector 182). Connector 182 may take the form of a circumferential projection or recess configured to engage a complementary circumferential lip or recess of a diffuser (see FIG. 7C). The lip-to-lip engagement may resist axial separation between collar 104d and the diffuser while permitting relative rotational movement therebetween. In this configuration, collar 104d may be rotationally fixed relative to a shade via indexes 160b while remaining freely rotatable relative to a diffuser engaged through connector 182. This arrangement may reduce torsional stresses on threaded diffuser connections during installation or adjustment.

The connector may be part of the support structure 166 extending inward from the bottom surface 156c. Support structure 166 may include one or more panels 172b defining center opening 174. Center opening 174 may be shaped to receive lighting support structure 198, such as an extruded member, rod, conduit, or structural element extending along a longitudinal axis of the modular lighting fixture. In certain embodiments, center opening 174 includes keyed geometry, flats, or corners that rotationally secure lighting support structure 198 relative to collar 104d. Fasteners may be inserted through apertures defined in support structure 166 to secure lighting support structure 198 to collar 104d.

FIG. 7C illustrates a cross-sectional view of collar 104d engaged with locking diffuser 102n and lighting support structure 198. As shown, connector 182 engages a complementary lip of locking diffuser (connector 192) 102n in a lip-to-lip arrangement. This engagement resists axial separation between collar 104d and locking diffuser 102n while permitting relative rotational movement therebetween.

Further, the lighting support structure 198 is shown to extend through the center opening 174 of the collar 104d and into the locking diffuser 102n. In the illustrated embodiment, lighting support structure 198 includes one or more light-emitting elements, such as LED diodes, represented schematically as modules positioned along the length of structure 198. These LED diodes may be mounted to a board, strip, or extrusion forming part of the lighting support structure 198.

As further shown, lighting support structure 198 maintains a substantially centered position within locking diffuser 102n. This centered arrangement helps maintain a consistent radial spacing between lighting support structure 198 and the inner walls of locking diffuser 102n. Maintaining consistent spacing may promote uniform light distribution through the diffuser and reduce localized hotspots. Additionally, the centered support may contribute to structural stability by limiting the lateral deflection of locking diffuser 102n relative to lighting support structure 198.

In operation, the collar-diffuser-support assembly shown in FIG. 7C may be inserted into a shade such that locking diffuser 102n extends into the internal space of the shade. Because collar 104d is rotationally secured relative to the shade while remaining rotatable relative to locking diffuser 102n, rotational adjustments of the collar and lighting support structure 198 may occur without transmitting torsional forces to the diffuser bar. When the lighting support structure 198 is additionally supported at an opposing end cap, the collar and end cap provide spaced support points that promote axial alignment, reduce deflection, and maintain centered positioning of locking diffuser 102n, regardless of whether the modular lighting fixture is oriented vertically, horizontally, or at an angle.

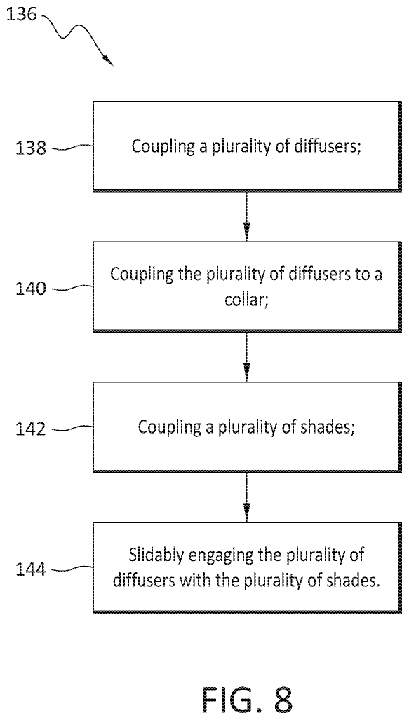

FIG. 8 illustrates a method 136 of assembling a modular light fixture of the present disclosure. For example, FIG. 8 shows that method 136 can comprise act 138 of coupling a plurality of diffusers. Act 138 can include engaging a connector of a first diffuser with a connector of a second diffuser. Act 138 can be repeated for any number of diffusers.

FIG. 8 shows that method 136 can further comprise act 140 of coupling the plurality of diffusers to a collar. Act 140 can include threadingly engaging a connector of a first diffuser with threads disposed on a collar of the present disclosure. In one embodiment, engagement between the collar and the first diffuser includes clips, lips, threads, clasps, hooks, snaps, or similar.

FIG. 8 shows that method 136 can comprise act 142 of coupling a plurality of shades. Act 142 can include inserting the connection element of a first shade into the neck of a second shade. Act 142 can also include twisting the first shade relative to the second shade to lock the shades together by way of one or more indexes and/or magnets.

FIG. 8 shows that method 136 can also comprise act 144 of slidably engaging the plurality of diffusers with the plurality of shades. Act 144 may include slidably engaging the fins of a diffuser or diffuser bar with slots defined by the connection element of the first shade and the neck of the second shade. Act 144 may also include twisting the collar relative to the first and second shade to engage indexes and/or magnets between the neck of the first shade and the connection element of the second shade.

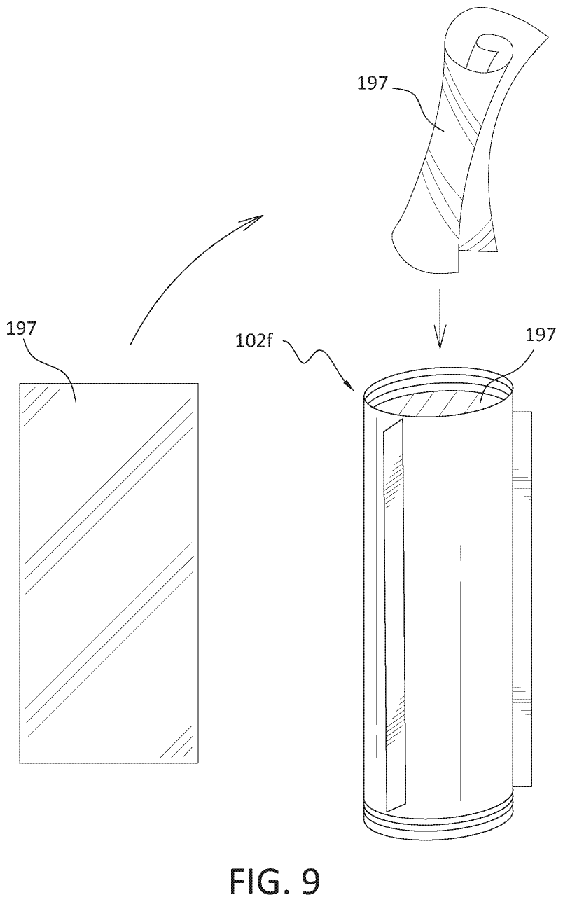

FIG. 9 illustrates a sequence of inserting film 197 into diffuser 102f. An assembler can first roll or fold film 197. The assembler can then insert film 197 into an opening of diffuser 102f. Once inserted, film 197 is free to unfurl inside diffuser 102f and frictionally retain and conform itself inside the inner surface of diffuser 102f. Film 197 can be a transparent or semi-transparent material. Film 197 can be colored or tinted. Thus, an assembler can use film 197 to allow a modular light fixture with a white light to produce light of varying colors without replacing the lighting element. In another embodiment, a manufacturer can construct diffuser 102f with a colored material to achieve a similar goal of allowing a white-light lighting element to provide colored light to a user. Alternatively, each diffuser can be made with a color, rather than using a film. For example, the diffuser may be extruded using colored pellets of different shades, hues, or chromas.

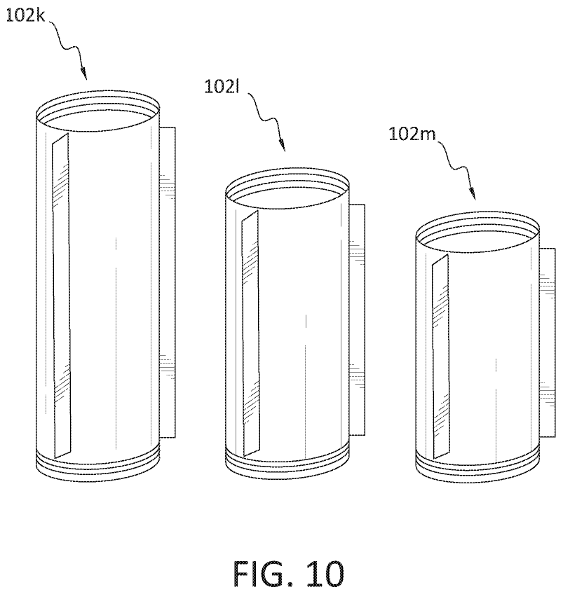

FIG. 10 illustrates diffusers 102k, 102l, and 102m. FIG. 10 illustrates that diffusers of the present disclosure can be of varying length. A manufacturer can produce diffusers longer or shorter to provide functional or aesthetic benefits. For example, a manufacturer can produce a short diffuser, such as diffuser 102m, to allow the diffuser to fit within a short shade. In another example, an assembler can cut a diffuser to a specific length.

The present disclosure teaches innovative modular light fixtures designed for both public and private spaces, emphasizing ease of assembly and customization. The modular design allows users to easily configure and reconfigure the fixtures to suit their aesthetic and functional needs, offering a cost-effective solution for personalized lighting.

Manufacturers and end users can construct these modular light fixtures using various materials through an additive manufacturing or 3D printing process. These processes provide versatility in material choice, allowing for a wide range of design possibilities and ensuring that the fixtures meet diverse aesthetic and functional requirements.

The ability to easily disassemble and reassemble these fixtures for cleaning or reconfiguration is a significant advantage. It enhances the fixtures' longevity and allows users to adapt their lighting to changing needs and preferences. Using retention mechanisms can allow the components of a light fixture to stay in place while still being easy to adjust. The locking diffusers can prevent the modular light fixtures from accidentally coming apart over time without the help of an assembler. Overall, the modular light fixtures of the present disclosure provide a forward-thinking approach to lighting design, combining practicality with aesthetic flexibility.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A modular light fixture comprising:
a plurality of diffusers configured to couple end-to-end to form a diffuser bar having a first terminal end and a second terminal end;
wherein each diffuser comprises:
an outer shell extending along a longitudinal axis;
an internal bore extending along substantially an entire length of the outer shell;
a first connector at a first end and a second connector at a second end, the second connector being a threaded portion; and
one or more fins extending radially from an outer surface of the outer shell, the one or more fins being selectively engageable with the modular light fixture.

2. The modular light fixture of claim 1, further comprising a collar and a shade, wherein:
the first connector of a first diffuser of the plurality of diffusers engages a support structure of the collar; and
a neck of the shade engages an index of the collar.

3. The modular light fixture of claim 2, wherein:
the one or more fins of the first diffuser engage with one or more slots defined by the neck of the shade; and
the one or more fins prevent the shade from rotating relative to another shade.

4. The modular light fixture of claim 2, wherein:
the support structure of the collar includes a circumferential lip; and
the first connector of the first diffuser comprises a corresponding lip configured to snap over the circumferential lip of the support structure to permit rotational movement while inhibiting axial separation.

5. The modular light fixture of claim 1, further comprising:
a collar that engages the first terminal end of the diffuser bar;
an end cap that engages the second terminal end of the diffuser bar; and
a lighting support structure that is suspended within the diffuser bar through engagement between the collar and the end cap.

6. The modular light fixture of claim 5, wherein the end cap comprises a pin that extends into the lighting support structure.

7. The modular light fixture of claim 5, wherein:
the end cap comprises a first part and a second part;
the first part is received by the second part and rotated freely when engaged with the second part; and
the first part engages the lighting support structure while the second part engages the second terminal end of the diffuser bar.

8. The modular light fixture of claim 1, further comprising a plurality of shades coupled together in a stacked configuration wherein the one or more fins engage with slots defined by the plurality of shades to resist rotation of the plurality of shades relative to each other.

9. The modular light fixture of claim 1, further comprising a collar, an end cap, and a plurality of shades, wherein the diffuser bar rotates freely relative to at least one of the collar or the end cap and is locked rotationally by the one or more fins relative to the plurality of shades.

10. The modular light fixture of claim 1, wherein the threaded portion comprises an internal thread along the internal bore that extends along at least a quarter of an overall length of the outer shell.

11. The modular light fixture of claim 1, wherein the one or more fins of each diffuser are aligned with corresponding fins of an adjacent diffuser when coupled end-to-end, such that the diffuser bar includes at least one substantially continuous fin extending along a length of the diffuser bar.

12. A method of assembling a modular lighting fixture of claim 1 comprising:
engaging a first diffuser with a second diffuser;
coupling the first diffuser to a collar;
coupling a first shade to a second shade;
slidably engaging the first and second shades to the first diffuser and the second diffuser; and
securing a neck of the first shade to the collar.

13. A diffuser for use in a modular light fixture comprising:
an outer shell having a length;
an internal bore extending through the outer shell and defining an opening at a first end and a second end of the outer shell;
a first connector disposed at the first end;
a second connector disposed at the second end, the second connector comprising an internal threaded portion that extends along at least a quarter of the length of the outer shell; and
one or more fins extending radially from an outer surface of the outer shell,
wherein:
the one or more fins selectively engage notches within the modular light fixture, such that a first shade of the modular light fixture and a second shade of the modular light fixture cannot rotate relative to each other.

14. The diffuser of claim 13, wherein the internal threaded portion extends for the length of the outer shell.

15. A collar and diffuser assembly for use in modular light fixtures comprising:
a collar comprising:
a body having an upper surface and a lower surface,
one or more walls extending from the lower surface of the body,
one or more apertures extending through the body, and
a connection element; and
a diffuser comprising:
an outer shell extending along a longitudinal axis, and
a connector configured to engage the connection element of the collar;
wherein:
the connection element of the collar engages the connector of the diffuser and resists axial separation while allowing rotational movement of the diffuser relative to the collar.

16. The collar and diffuser assembly of claim 15, wherein each of the connection element and the connector comprises a circumferential lip.

17. The collar and diffuser assembly of claim 15, wherein neither the connection element nor the connector is a threaded element.

18. The collar and diffuser assembly of claim 15, further comprising a lighting support structure that engages the collar and is suspended within an internal bore of the outer shell.

19. The collar and diffuser assembly of claim 15, further comprising a cap that is coupled to an end of the diffuser opposite the connector.

20. The collar and diffuser assembly of claim 15, further comprising one or more additional diffusers, wherein the diffuser and the one or more additional diffusers selectively engage in an end-to-end configuration.
